(19) United States
(12) Patent Application Publication
(10) Pub. No.: US 2007/0202016 A1
(43) Pub. Date: Aug. 30, 2007

(54) Automatic fluidic system and reagent container and method for transferring a reagent into the automatic fluidic system

(76) Inventors: Aaron Mason, Wilmington, MA (US); Robert Baker, Concord, NH (US); Paul Haigh, Londonderry, NH (US); Patrick Engel, Watertown, MA (US)

Correspondence Address: Patrick W. Rasche;Armstrong Teasdale LLP, One Metropolitan Square, Suite 2600, St. Louis, MO, 63102, US

(21) Appl. No.: 11/363,246

(22) Filed: Feb. 27, 2006

(51) Int. Cl. B01L 3/00

(52) U.S. Cl. 422/102

(57) ABSTRACT

A reagent container for use in an automatic fluidic system, the automatic fluidic system, and a method for transferring reagent to the automatic fluidic system are provided. The reagent container includes a portable reservoir configured to hold a discrete volume of a reagent therein. The reagent container further includes a needleless valve removably secured to the portable reservoir. The needleless valve has a valve housing, a valve portion, and a cap member. The valve housing has first and second interior regions and a first opening disposed between the first and second interior regions. The second interior region fluidly communicates with an interior region of the portable reservoir. The valve portion has a closed operational position for preventing reagent flow through the first opening from the portable reservoir. The valve portion has an open operational position for allowing reagent flow through the first opening from the portable reservoir. The cap member is configured to removably secure the valve housing to the portable reservoir. The reagent container further includes an elongated conduit having first and second ends. The elongated conduit is secured to the valve housing at the first end. The elongated conduit has a length such that the second end is disposed proximate to a bottom wall of the portable reservoir when the portable reservoir is secured to the valve housing such that when the valve portion has the open operational position, a predetermined volume of reagent in the portable reservoir flows through the elongated conduit, the second interior region, and the first opening to the first interior region.

### BACKGROUND

An automatic fluidic system having a reagent container for transferring a reagent into the automatic fluidic system is provided.

Sequential Injection Analysis (SIA) systems and Flow Injection Analysis (FIA) systems can analyze a chemical or a biological sample. In order to analyze these samples, these systems can utilize reagents. However, when the reagents are exposed to an uncontrolled environment, contaminants can be introduced into the reagents. For example, the reagents can be exposed to an uncontrolled environment when the reagent is stored or when the reagent is transferred to the automatic fluidic system. The contaminants can degrade the operational effectiveness of the reagents.

Therefore, an automatic fluidic system having a reagent container that can store and transfer reagents while maintaining the reagents in a controlled environment is needed.

### SUMMARY OF THE INVENTION

A reagent container for use in an automatic fluidic system in accordance with an exemplary embodiment is provided. The reagent container includes a portable reservoir configured to hold a discrete volume of a reagent therein. The reagent container further includes a needleless valve removably secured to the portable reservoir. The needleless valve has a valve housing, a valve portion, and a cap member. The valve housing has first and second interior regions and a first opening disposed between the first and second interior regions. The second interior region fluidly communicates with an interior region of the portable reservoir. The valve portion has a closed operational position for preventing reagent flow through the first opening from the portable reservoir. The valve portion has an open operational position for allowing reagent flow through the first opening from the portable reservoir. The cap member is configured to removably secure the valve housing to the portable reservoir. The reagent container further includes an elongated conduit having first and second ends. The elongated conduit is secured to the valve housing at the first end. The elongated conduit has a length such that the second end is disposed proximate to a bottom wall of the portable reservoir when the portable reservoir is secured to the valve housing such that when the valve portion has the open operational position, a predetermined volume of reagent in the portable reservoir flows through the elongated conduit, the second interior region, and the first opening to the first interior region.

An automatic fluidic system in accordance with another exemplary embodiment is provided. The automatic fluidic system includes an automatic fluidic device configured to receive a reagent therein. The automatic fluidic system further includes a reagent container in fluid communication with the automatic fluidic device. The reagent container has a portable reservoir, a needleless valve, and an elongated conduit. The portable reservoir is configured to hold a discrete volume of the reagent therein. The needleless valve is removably secured to the portable reservoir. The needleless valve has a valve housing, a valve portion, and a cap member. The valve housing has first and second interior regions and a first opening disposed between the first and second interior regions. The second interior region fluidly communicates with an interior region of the portable reservoir. The valve portion has a closed operational position for preventing reagent flow through the first opening from the portable reservoir. The valve portion has an open operational position for allowing reagent flow through the first opening from the portable reservoir. The cap member is configured to removably secure the valve housing to the portable reservoir. The elongated conduit has first and second ends. The elongated conduit is secured to the valve housing at the first end. The elongated conduit has a length such that the second end is disposed proximate to a bottom wall of the portable reservoir when the portable reservoir is secured to the valve housing. The automatic fluidic system further includes a valve actuation member. The valve actuation member is operably coupled between the first reagent container and the automatic fluidic device. The valve actuation member is configured to be removably received in the first interior region of the valve housing to transition the valve portion from the closed operational position to the open operational position, such that a predetermined volume of reagent in the portable reservoir flows through the elongated conduit, the second interior region, the first opening to the first interior region, and further to the automatic fluidic device.

A method for delivering a predetermined volume of reagent from a reagent container in accordance with another exemplary embodiment is provided. The reagent container has a portable reservoir for holding a reagent, a needleless valve, and an elongated conduit. The needleless valve is coupled to the elongated conduit. The needleless valve has a valve housing and a valve portion. The valve housing has first and second interior regions and a first opening disposed between the first and second interior regions. The elongated conduit has first and second ends. The elongated conduit is secured to the valve housing at the first end. The method includes inserting the elongated conduit into an interior region of the portable reservoir. The method further includes securing the needleless valve to the portable reservoir such that the second end of the elongated conduit is disposed proximate to a bottom wall of the portable reservoir and the second interior region of the valve housing fluidly communicates with the interior region of the portable reservoir. The method further includes inserting a valve actuation member in the first interior region of the valve housing such that the valve portion transitions from a closed operational position to an open operational position to allow reagent flow through the first opening of the valve housing. The method further includes pumping the predetermined volume of reagent from the portable reservoir through the elongated conduit, the second interior region, and the first opening to the first interior region of the valve housing.

The above described and other features are exemplified by the following figures and detailed description.

### BRIEF DESCRIPTION OF THE DRAWINGS

FIG. 1 is a side view of a reagent container having a portable reservoir, a needleless valve, and an elongated conduit in accordance with an exemplary embodiment;

FIG. 2 is another side view of the reagent container of FIG. 1;

FIG. 3 is a cross sectional view of the reagent container of FIG. 1;

FIG. 4 is another cross sectional view of the reagent container of FIG. 3 coupled to a valve actuation member;

FIG. 5 is a cross sectional view of another reagent container in accordance with an exemplary embodiment;

FIG. 6 is another cross sectional view of the reagent container of FIG. 5 coupled to another valve actuation member;

FIG. 7 is a prospective view of an automatic fluidic device coupled through first and second valve actuation members to first and second reagent containers; and

FIG. 8 is a flow chart diagram of a method for transferring reagent to an automatic fluidic system.

### DETAILED DESCRIPTION OF EXEMPLARY EMBODIMENTS

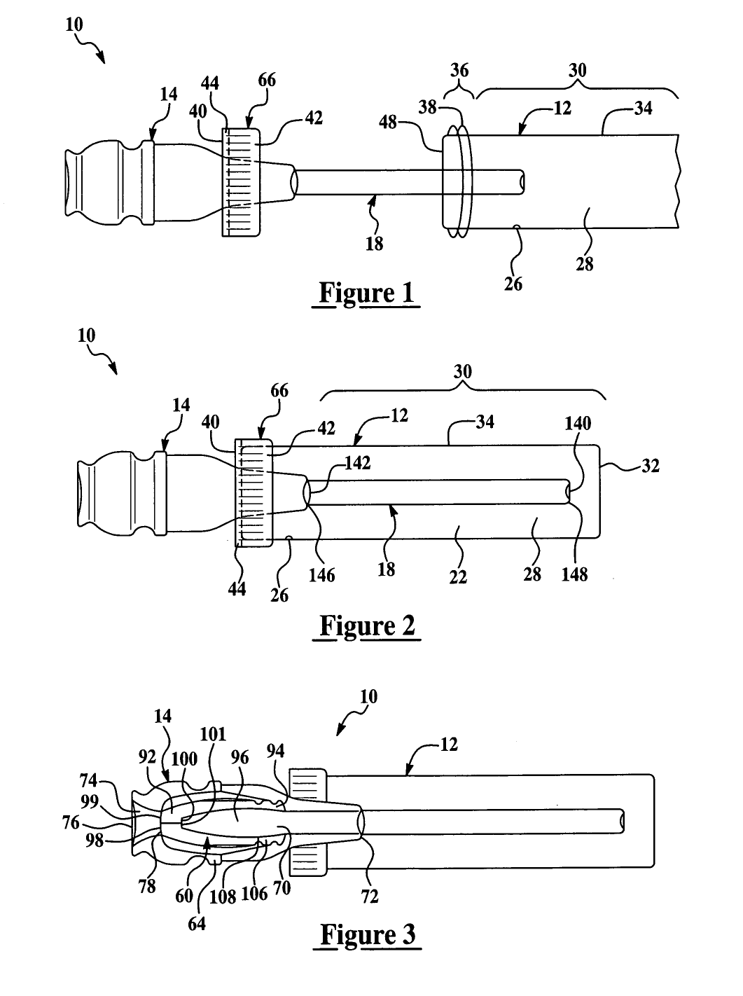

Referring to FIGS. 1, 2 and 7, a reagent container 10 for transferring a reagent 22 through a valve actuation member 150 to an automatic fluidic device 24 is shown. The reagent container 10 includes an elongated conduit 18 secured to a needleless valve 14, and a portable reservoir 12 removably secured to the needleless valve 14.

The portable reservoir 12 is provided to hold a discrete volume of the reagent 22. The portable reservoir 12 includes a tubular wall 34 and a bottom wall 32. The tubular wall 34 and bottom wall 32 define an interior region 28. Tubular wall 34 includes a lower portion 30 and an upper portion 36. The upper portion 36 has threads 38 configured to couple the reservoir 12 to the needleless valve 14. The portable reservoir 12 can be manufactured from materials suitable for storing the reagent 22. General properties of the materials of the portable reservoir 12 include low reactivity with the reagent 22, and the ability to store the reagent 22 in a controlled environment. In one exemplary embodiment, the portable reservoir is constructed from plastic. Other exemplary materials that can be utilized for forming the portable reservoir 12 include glass, metals, and the like.

Tubular wall 34 has an air inlet 26 extending therethrough. The air inlet 26 is provided to allow airflow into the portable reservoir 12 to displace fluid exiting the portable reservoir 12. The air inlet 26 has a relatively small size so that reagent 22 does not exit the portable reservoir 12 through the air inlet 26 and contaminants do not enter into the portable reservoir 12. In particular, the air inlet 26 is disposed in the portable reservoir 12 proximate an end 48 to minimize contact with reagent 22 when the reagent container 10 is in an upright position (a position wherein the portable reservoir 12 is disposed below the needleless valve 14). Although in an exemplary embodiment, the air inlet 26 is disposed through the portable reservoir 12, it is to be understood that in an alternative exemplary embodiment, the air inlet 26 can be disposed in other locations in the reagent container 10 in fluid communication with the interior region 28 of the portable reservoir 12. For example, the air inlet 26 can extend through a cap member 66.

The air inlet 26 can have a filter member (not shown) disposed therein. The filter member can filter contaminants in the air as the air travels through the air inlet 26. The filter member can include fibrous material configured to prevent the flow of submicron particles or large molecules (i.e., molecules larger than oxygen and nitrogen) through the air inlet 26. Further, the air inlet 26 can have a check valve (not shown) disposed therein. The check valve is configured to allow airflow into the portable reservoir 12 when reagent 22 is drawn from the portable reservoir 12 through the needleless valve 14, without allowing reagent flow out of the portable reservoir 12 through the air inlet 26.

The reagent 22 is a biological or chemical reagent utilized in the automatic fluidic device 24. The reagent 22 is disposed in the portable reservoir 12 at a location remote from the automatic fluidic device 24. For example, the reagent 22 can be disposed in the portable reservoir in a clean room to prevent contaminants from being introduced into the reagent 22. The portable reservoir 12 is secured to the needleless valve 14 in the clean room.

Referring to FIGS. 2-4 the needleless valve 14 is provided to maintain selective fluid communication between the portable reservoir 12 and the valve actuation member 150. The needleless valve 14 includes the cap member 66, a valve housing 64, and a valve portion 60.

The cap member 66 is provided to secure the portable reservoir 12 to the needleless valve 14, to form an airtight seal between the portable reservoir 12 and the needleless valve 14. The cap member 66 includes a base portion 40 and a collar 42. The base portion 40 has a gasket 44 disposed thereon. The gasket 44 is configured to form a compressive, airtight seal between the end 48 of the portable reservoir 12 and the base portion 40 of the cap member 66. In an exemplary embodiment, the gasket 44 is constructed from rubber. In an alternate exemplary embodiment, the gasket 44 is constructed from a polymeric elastomer. The collar 42 has receiving threads disposed on an inner surface thereof. The receiving threads are configured to receive the threads 38 of the portable reservoir 12 therein. The cap member 66 is secured to the valve housing 64 by disposing an adhesive material between the cap member 66 and the valve housing 64. In another exemplary embodiment, the cap member 66 is compressively sealed to the valve housing 64. Further, in another exemplary embodiments the cap member 66 can be secured to the valve housing 64 utilizing other methods such as heat fusing methods, or by co-forming the cap member 66 and the valve housing 64 as a single piece of material.

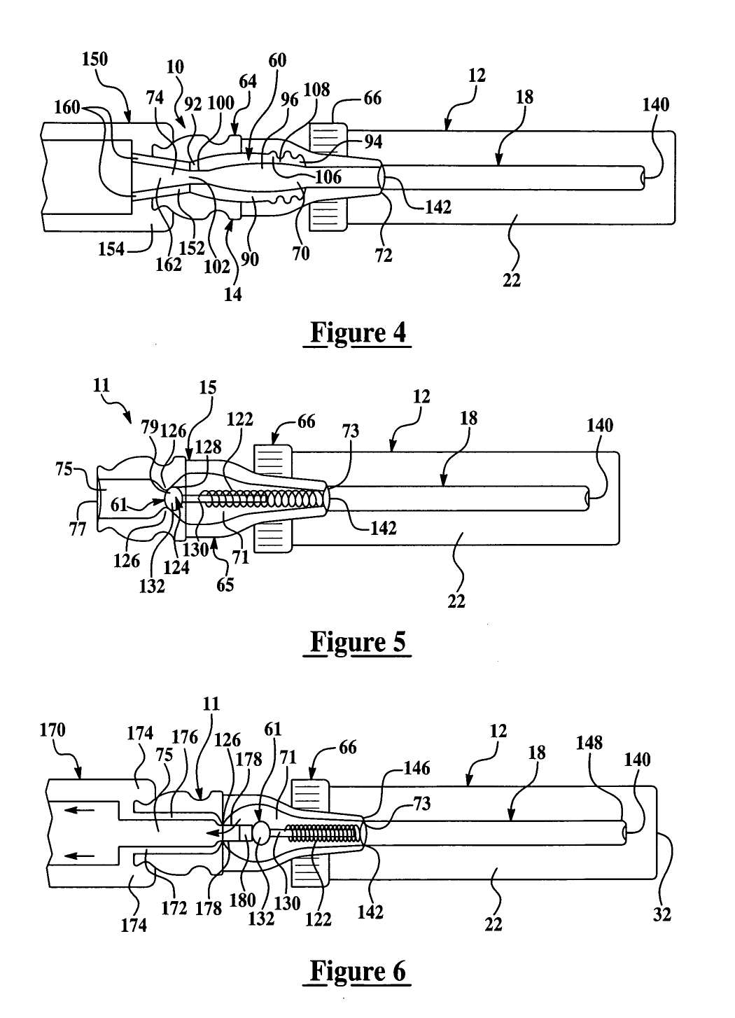

Referring to FIGS. 3 and 4, valve housing 64 is a rigid casing defining the interior region 70 and an interior region 74. The valve housing 64 has an opening 78 disposed between the interior region 74 and the interior region 70. The interior region 70 extends from an input end 72 to the opening 78. The interior region 74 extends from an output end 76 to the opening 78.

The valve portion 60 is disposed in the interior region 70. The valve portion 60 can move between an open operational position and a closed operational position. In the open operational position as shown in FIG. 4, the valve portion 60 provides fluid communication between the interior region 70 and the interior region 74. In the closed operational position as shown in FIG. 3, the valve portion 60 prevents fluid communication between the interior region 70 and the interior region 74. The valve portion 60 includes a resilient member 90. The resilient member 90 includes an end 92 and an end 94 and has a flow channel 96 extending therethrough. The end 92 includes sections 98, 99. The sections 98, 99 contact one another section at contact edges 100, 101. The end 92 is compressively sealed by a biasing force when the valve portion 60 has the closed operational position. The end 92 defines an opening 102 when the valve portion 60 has the open operational position. The opening 102 provides fluid communication between the interior region 70 and the interior region 74.

The resilient member 90 includes thick wall sections 106 and thin wall sections 108 to accommodate movement of the resilient member 90 when the valve portion 60 transitions between the closed operational position and the open operational position.

The resilient member 90 has resilient properties to provide a biasing force for urging sections 98 and 99 against one another to have a normally closed operational position. The resilient member 90 is constructed from rubber such that, when stretched, the resilient member 90 will contract to reach a lower energy state. In particular, the contracting forces of the resilient material 90 provide the biasing force to urge sections 98 and 99 against one another to seal the end 92 and to maintain the valve portion 60 in the closed operational position. In other exemplary embodiments, the resilient member 90 is made from a polymeric elastomer material. Further, the resilient member 90 has self-adhesive properties and gripping properties to seal the end 92.

Referring to FIG. 4, valve actuation member 150 is provided to be fluidly coupled to the needleless valve 14 and transport reagent 22 out of the reagent container 10. The valve actuation member 150 is also fluidly coupled to the automatic fluidic device 24. The actuation member 150 includes a nozzle 152 and a coupling member 154. The nozzle 152 has an outer wall 160 defining an inlet region 162. The outer wall 160 is configured to contact the resilient member 90 to provide an actuating force to transition the valve portion 60 from the closed operational position to the open operational position. In particular, the outer wall 106 contacts sections 98 and 99 to urge sections 98 and 99 away from one another to form an opening 102 for transitioning the valve portion from the closed operational position to the open operational position. The inlet region 162 is configured to allow reagent 22 to flow from the opening 102 into the actuation member 150. The coupling member 154 is configured to secure the actuation member 150 to the valve housing 64.

When the needleless valve 14 is received in the valve actuation member 150, the coupling member 154 secures the valve actuation member 150 to the valve housing 64. The securing forces between the coupling member 154 and the valve housing 64 maintain an actuating force greater than the biasing force, thereby maintaining the valve portion 60 in the open operational position.

Referring to FIGS. 5 and 6, in another exemplary embodiment, a reagent container 11 for transferring the reagent 22 into the automatic fluidic device 24 is shown. The reagent container 11 includes the elongated conduit 18 secured to a needleless valve 15 and the portable reservoir 12 removably secured to the needleless valve 15.

The needleless valve 15 is provided to maintain selective fluid communication between the portable reservoir 12 and a valve actuation member 170. The needleless valve 15 includes a valve housing 65, a valve portion 61, and the cap member 66.

The valve housing 65 is a rigid casing defining the interior region 71 and an interior region 75. Valve housing 65 has an opening 79 disposed between the interior region 71 and the interior region 75. The interior region 71 extends from an input end 73 to the opening 79. The interior region 75 extends from an output end 73 to the opening 79. Valve housing 65, further has a seating portion 126 surrounding the opening 79 and a ring-shaped gasket 128 disposed on the seating portion 126.

The valve portion 61 is disposed in the interior region 71. The valve portion 61 can move between an open operational position and a closed operational position. In the open operational position, the valve portion 61 provides fluid communication between the interior region 71 and the interior region 75. In the closed operational position, the valve portion 61 prevents fluid communication between the interior region 71 and the interior region 75. The valve portion 61 includes a spring loaded plunger comprising a spring 122 and a plunger 124. The plunger 124 includes a shaft 130 and a head 132. The spring 122 is secured between the shaft 130 the valve housing 65. The spring 122 provides the biasing force to seal the head 132 against the ring-shaped gasket 128 to maintain the valve portion 61 in the closed operational position. When the valve portion 61 is in the open operational position, the head 132 is biased away from the gasket 128 allowing the fluid flow between the interior region 71 and the interior region 75.

A valve actuation member 170 is provided to be fluidly coupled to valve 15 and to transport reagent 22 out of the reagent container 11. The valve actuation member 170 is also fluidly coupled to automatic fluidic device 24. The valve actuation member 170 includes a nozzle 172 and a coupling member 174. The nozzle 172 includes a cylindrical wall portion 176 extending from the coupling member 174 to a top portion 180. The cylindrical wall portion 176 has an inlet region 178 disposed therethrough that provides fluid communication into the actuation member 170. The top portion 180 is configured to move the head 132 away from opening 79 to transition the valve portion 61 from the closed operational position to the open operational position. The coupling member 174 is configured to secure the valve actuation member 170 to the valve housing 65.

When the needleless valve 15 is received by the valve actuation member 170, the coupling member 174 secures to the valve housing 65. The securing forces between the coupling member 174 and the valve housing 65 provide an actuating force greater than the biasing force, thereby maintaining the valve portion 61 in the open operational position.

Referring to FIGS. 2-4, the elongated conduit 18 is provided to route fluid from the portable reservoir 12 to the interior region 70. The elongated conduit 18 is a hollow tube having an inlet region 140 at an end 148 and an outlet 142 at an end 146. The elongated conduit 18 extends from the interior region 70 of the valve housing 64 to a location proximate the bottom wall 32 of the portable reservoir 12 when the portable reservoir 12 is secured to the valve portion 64. In an exemplary embodiment, the end 148 of the elongated conduit 18 is about 0.1 millimeters to about 5 millimeters from the bottom wall 32 of the portable reservoir 12 when the portable reservoir 12 is secured to the valve housing 64. However, in other exemplary embodiments, the elongated conduit 18 is disposed at other distances from the bottom wall 32 of the portable reservoir 12. At the end 146, the elongated conduit is secured inside the interior region 70 of the valve housing 64.

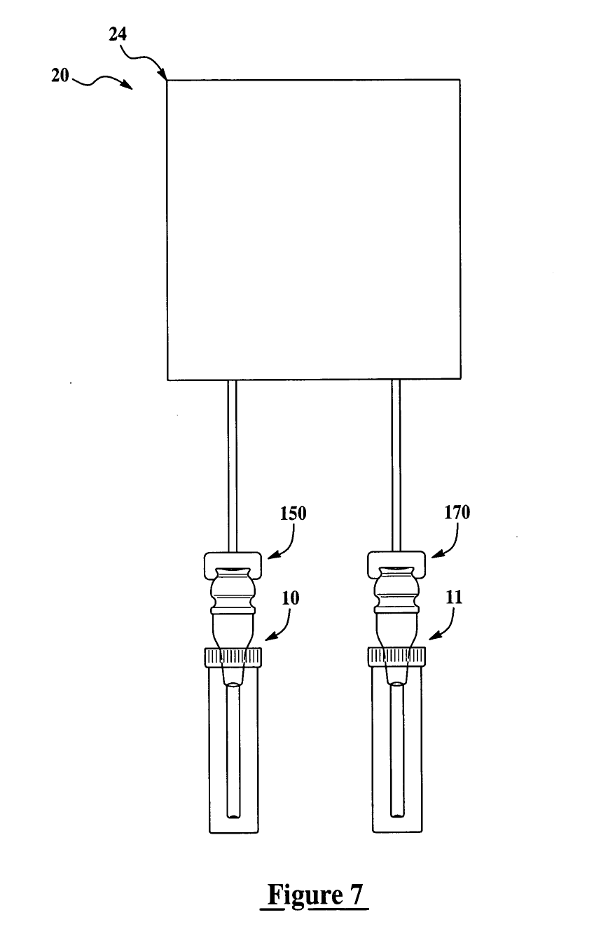

Referring to FIG. 7, an automatic fluidic system 20 for receiving reagents from reagent containers 10, 11 is shown. The automatic fluidic system 20 includes the reagent container 10, a reagent container 11, the valve actuation member 150, the valve actuation member 170, and the automatic fluidic device 24.

The reagent containers 10 and 11 are provided to transfer reagent to the automatic fluidic device 24. The reagent containers 10 and 11 are coupled to the valve actuation members 150 and 170, respectively. The reagent container 10 is in fluid communication with the automatic fluidic device 24 through the valve actuation member 150 such that the automatic fluidic device 24 can pump reagent 22 from the reagent container 10. Similarly, the reagent container 11 is in fluid communication with the automatic fluidic device 24 through the valve actuation member 170 such that the automatic fluidic system 24 can pump reagent from the reagent container 11.

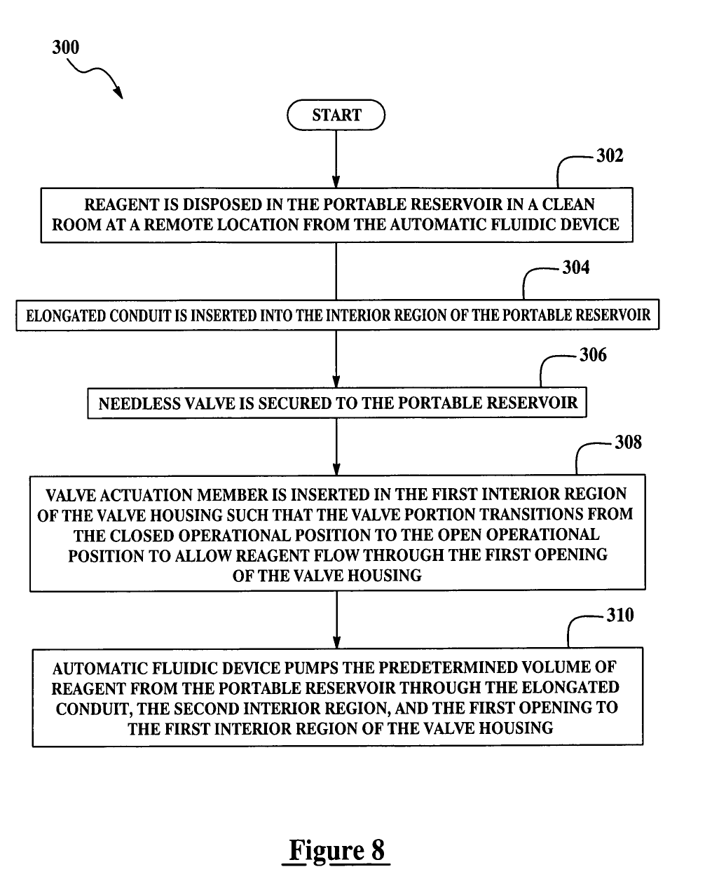

Referring to FIG. 8, a method 300 for transferring reagent 22 from the reagent container 10 will now be described.

At step 302, the reagent 22 is disposed in the portable reservoir in a clean room at a remote location from the automatic fluidic device 24. However, in alternative exemplary embodiments the reagent 22 can be disposed through the interior region 74 of the valve housing 64, when the valve portion 60 is in the open operational position.

At step 304, the elongated conduit 18 is inserted into the interior region 28 of the portable reservoir 12.

At step 306, the needleless valve 14 is secured to the portable reservoir 12 such that the second end 148 of the elongated conduit is disposed proximate to a bottom wall 32 of the portable reservoir 12 and the second interior region 70 of the valve housing 64 fluidly communicates with the interior region 28 of the portable reservoir 12.

At step 308, the valve actuation member 150 is inserted in the first interior region 70 of the valve housing 64 such that the valve portion 60 transitions from a closed operational position to an open operational position to allow reagent flow through the first opening 78 of the valve housing 64.

At step 310, the automatic fluidic device 24 pumps a predetermined volume of reagent 22 from the portable reservoir 12 through the elongated conduit 18, the second interior region 70, and the first opening 78 to the first interior region 74 of the valve housing 64. The reagent 22 is then routed from the first interior region 74 to the automatic fluidic device 24.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A reagent container for use in an automatic fluidic system, the reagent container comprising:
a portable reservoir configured to hold a discrete volume of a reagent therein;
a needleless valve removably secured to the portable reservoir, the needleless valve having a valve housing, a valve portion, and a cap member, the valve housing having first and second interior regions and a first opening disposed between the first and second interior regions, the second interior region fluidly communicating with an interior region of the portable reservoir, the valve portion having a closed operational position for preventing reagent flow through the first opening from the portable reservoir, the valve portion having an open operational position for allowing reagent flow through the first opening from the portable reservoir, the cap member being configured to removably secure the valve housing to the portable reservoir; and
an elongated conduit having first and second ends, the elongated conduit being secured to the valve housing at the first end, the elongated conduit having a length such that the second end is disposed proximate to a bottom wall of the portable reservoir when the portable reservoir is secured to the valve housing, such that when the valve portion has the open operational position, a predetermined volume of reagent in the portable reservoir flows through the elongated conduit, the second interior region, and the first opening to the first interior region.

2. The reagent container of claim 1, wherein the valve portion comprises a resilient member having a third end and a fourth end and a flow channel extending through the resilient member from the third end to the fourth end of the resilient member, the third end of the resilient member having a second opening fluidly communicating with the flow channel that is compressively sealed when a valve actuation member is not disposed in the first interior region of the valve housing to prevent reagent flow through the resilient member, the second opening being unsealed when the valve actuation member is disposed in the first interior region of the valve housing and contacts the third end of the resilient member to allow reagent flow through the resilient member, the fourth end of the resilient member having a third opening fluidly communicating with the flow channel and the elongated conduit.

3. The reagent container of claim 1, wherein the valve housing has a seating portion surrounding the first opening, and the valve portion comprises a spring loaded plunger configured to seal against the seating portion for closing the first opening when a valve actuation member is not disposed in the first interior region of the valve housing, the spring loaded plunger being biased away from the seating portion when the valve actuation member is disposed in the first interior region of the valve housing and contacts the plunger to allow reagent to flow through the first opening.

4. The reagent container of claim 1, wherein the second end of the elongated conduit is disposed about 0.1 millimeters to about 5 millimeters from the bottom wall of the portable reservoir when the portable reservoir is secured to the needleless valve.

5. The reagent container of claim 1, wherein the portable reservoir has an air inlet disposed therethrough, the air inlet being configured to provide air to the portable reservoir as reagent is removed from the portable reservoir.

6. The reagent container of claim 5, wherein a filter is disposed in the air inlet.

7. The reagent container of claim 5, wherein a check valve is disposed in the air inlet.

8. The reagent container of claim 1, wherein the reagent container is threadably secured to the cap member of the needleless valve.

9. An automatic fluidic system, comprising:
an automatic fluidic device configured to receive a reagent therein;
a reagent container in fluid communication with the automatic fluidic device, the reagent container having a portable reservoir, a needleless valve, and an elongated conduit, the portable reservoir configured to hold a discrete volume of the reagent therein, the needleless valve removably secured to the portable reservoir, the needleless valve having a valve housing, a valve portion, and a cap member, the valve housing having first and second interior regions and a first opening disposed between the first and second interior regions, the second interior region fluidly communicating with an interior region of the portable reservoir, the valve portion having a closed operational position for preventing reagent flow through the first opening from the portable reservoir, the valve portion having an open operational position for allowing reagent flow through the first opening from the portable reservoir, the cap member being configured to removably secure the valve housing to the portable reservoir; the elongated conduit having first and second ends, the elongated conduit being secured to the valve housing at the first end, the elongated conduit having a length such that the second end is disposed proximate to a bottom wall of the portable reservoir when the portable reservoir is secured to the valve housing; and
a valve actuation member operably coupled between the reagent container and the automatic fluidic device, the valve actuation member being configured to be removably received in the first interior region of the valve housing to transition the valve portion from the closed operational position to the open operational position, such that a predetermined volume of reagent in the portable reservoir flows through the elongated conduit, the second interior region, the first opening to the first interior region, and further to the automatic fluidic device.

10. The automatic fluidic device of claim 9, wherein the reagent container is threadably secured to the cap member of the needleless valve.

11. The automatic fluidic device of claim 9, wherein the valve portion comprises a resilient member having a third end and a fourth end and a flow channel extending through the resilient member from the third end to the fourth end of the resilient member, the third end of the resilient member having a second opening fluidly communicating with the flow channel that is compressively sealed when the valve actuation member is not disposed in the first interior region of the valve housing to prevent reagent flow through the resilient member, the second opening being unsealed when the valve actuation member is disposed in the first interior region of the valve housing and contacts the third end of the resilient member to allow reagent flow through the resilient member, the fourth end of the resilient member having a third opening fluidly communicating with the flow channel and the elongated conduit.

12. The automatic fluidic device of claim 9, wherein the valve housing has a seating portion surrounding the first opening, and the valve portion comprises a spring loaded plunger configured to seal against the seating portion for closing the first opening when the valve actuation member is not disposed in the first interior region of the valve housing, the spring loaded plunger being biased away from the seating portion when the valve actuation member is disposed in the first interior region of the valve housing and contacts the plunger to allow reagent to flow through the first opening.

13. A method for delivering a predetermined volume of reagent from a reagent container, the reagent container having a portable reservoir for holding a reagent, a needleless valve, and an elongated conduit, the needleless valve coupled to the elongated conduit, the needleless valve having a valve housing and a valve portion, the valve housing having first and second interior regions and a first opening disposed between the first and second interior regions, and the elongated conduit having first and second ends, the elongated conduit being secured to the valve housing at the first end, the method comprising:
inserting the elongated conduit into an interior region of the portable reservoir;
securing the needleless valve to the portable reservoir such that the second end of the elongated conduit is disposed proximate to a bottom wall of the portable reservoir and the second interior region of the valve housing fluidly communicates with the interior region of the portable reservoir;
inserting a valve actuation member in the first interior region of the valve housing such that the valve portion transitions from a closed operational position to an open operational position to allow reagent flow through the first opening of the valve housing; and
pumping the predetermined volume of reagent from the portable reservoir through the elongated conduit, the second interior region, and the first opening to the first interior region of the valve housing.

14. The method of claim 13, wherein inserting the valve actuation member comprises engaging the valve actuation member against the valve portion to transition the valve portion from the closed operational position to the open operational position.

15. The method of claim 13, wherein inserting the valve actuation member comprises engaging the valve actuation member against a head of a spring loaded plunger to move the plunger away from the first opening.

16. The method of claim 13, further comprising routing the reagent from the first interior region of the valve housing to the automatic fluidic device.
